(19) United States
(12) Patent Application Publication
(10) Pub. No.: US 2026/0320664 A1
(43) Pub. Date: Oct. 15, 2026

(54) DYNAMIC ATTRIBUTE RANKING SYSTEM USING GEOMETRIC MEAN ANALYSIS OF CUSTOMER INTERACTIONS

(71) Applicant: Target Brands, Inc., Minneapolis, MN (US)

(72) Inventors: Cole Stiegler, Minneapolis, MN (US); Dakota Brown, St. Paul, MN (US); Jacob Leistico, Minneapolis, MN (US); Mansi Tripathi, Austin, TX (US)

(73) Assignee: Target Brands, Inc., Minneapolis, MN (US)

(21) Appl. No.: 19/178,646

(22) Filed: Apr. 14, 2025

(51) Int. Cl. G06Q 30/0601

(52) U.S. Cl. CPC G06Q 30/0629

(57) ABSTRACT

Systems and methods for evaluating attribute importance based on direct customer interaction data are provided. An example system evaluates attribute importance based on direct customer interaction data from two primary sources: facet clicks when customers select filtering options while browsing products, and search terms when customers enter search queries. Embodiments of the present disclosure provide several key technical advantages over conventional e-commerce attribute management systems.

### BACKGROUND

Online retail platforms utilize merchandise type attributes (MTAs) to capture different qualities, handling requirements, and quantifiable aspects of items. For example, a “Color Family” attribute may have values like “Red”, “Green”, “Blue”, etc. Large retailers maintain extensive attribute systems, with some having over 1,000 MTAs and 50,000 attribute-value pairs.

Creating new items in e-commerce systems requires assigning values to at least a minimum set of required attributes. However, the large number of possible attributes and values creates inefficiencies. For example, larger numbers of attributes may slow down initial item creation, lead to inconsistent attribute usage, and/or make it difficult to identify which attributes are most important to customers. The large number of attributes also complicates automation of attribute assignment, as not all attributes may be applicable to all items. Current approaches lack effective methods for quantifying attribute importance, which inhibits progress on improving item setup processes and customer experiences.

### SUMMARY

The present disclosure provides systems and methods for evaluating attribute importance based on direct customer interaction data. For example, in some embodiments, systems and methods are provided for evaluating attribute importance based on direct customer interaction data from two primary sources: facet clicks when customers select filtering options while browsing products, and search terms when customers enter search queries. Embodiments of the present disclosure provide several key technical advantages over conventional e-commerce attribute management systems.

In a first aspect, a computer-implemented method determines attribute importance in an e-commerce system by first receiving facet click data that reflects customer selections of facet values used for filtering products. Simultaneously, it collects search term data that captures customer search queries. The system then maps the facet click data to attribute-value pairs through a facet management mapping system while separately mapping the search term data to attribute-value pairs using string matching techniques. For each attribute, the system calculates three rankings: a first rank based on aggregated facet click counts, a second rank derived from aggregated search term counts, and a composite rank computed using the geometric mean of the first and second ranks. Finally, the system stores these composite rankings in a database, ensuring efficient access and analysis of attribute importance.

In a second aspect, a system for evaluating attribute importance in an e-commerce platform includes a database that stores merchandise type attributes and their associated values, a facet management system that maps facet selections to attribute-value pairs, and a search processing system that maps search terms to attribute-value pairs. Additionally, a ranking engine is configured to calculate first ranks based on facet selection counts, second ranks based on search term counts, and composite ranks by applying geometric means to the first and second ranks.

In a third aspect, a method for storing and retrieving attribute importance data in an e-commerce system involves storing daily aggregated data in a partitioned table, which includes facet click counts for attribute-value pairs, search term counts for attribute-value pairs, and predicted item types associated with interactions. The table is partitioned by date to enable efficient retrieval of time-based data, with separate tables maintained for facet management mappings, taxonomy values, and taxonomy assignments. Each partition stores attribute identifiers, attribute value identifiers, daily interaction counts, and item type associations. These tables are then joined to create aggregated views of attribute importance, facilitating efficient data retrieval and analysis.

### BRIEF DESCRIPTION OF THE DRAWINGS

FIG. 1 is a system architecture diagram illustrating the flow of data from customer interactions through facet clicks and search terms, to the item attribute mapping system, through the daily partitioned storage, and ultimately to the dashboard visualization system via the automation portal.

FIG. 2 is a data flow diagram showing the parallel processing paths for facet click mapping and search term string matching, including the intermediary mapping tables and aggregation processes leading to attribute rankings.

FIG. 3 is a database schema diagram illustrating the structure of the facet management table, taxonomy values table, taxonomy assignments table, and daily partitioned interaction table used to store and process attribute importance data.

FIG. 4 is a dashboard interface diagram showing filtering controls and attribute selection interfaces, with FIG. 4A displaying a type selection interface and FIG. 4B showing additional filtering capabilities.

FIG. 5 illustrates data mapping between tables showing how MTA values, item types, and search terms are processed and combined to generate attribute importance rankings.

FIG. 6 provides example visualizations showing attribute importance rankings through two views: FIG. 6A displaying MTA guest engagement metrics and FIG. 6B showing MTA value guest engagement data.

FIG. 7 illustrates two facet management interfaces, as FIGS. 7A and 7B, showing the internal naming conventions, guest-facing names, and attribute/value management capabilities.

FIG. 8 is a user interface flow diagram according to aspects of the present disclosure.

FIG. 9 is an example of a computing system with which aspects of the present disclosure may be implemented.

### DETAILED DESCRIPTION

The present disclosure provides systems and methods for evaluating attribute importance based on direct customer interaction data. For example, in some embodiments, systems and methods are provided for evaluating attribute importance based on direct customer interaction data from two primary sources: facet clicks when customers select filtering options while browsing products, and search terms when customers enter search queries. Embodiments of the present disclosure provide several key technical advantages over conventional e-commerce attribute management systems.

Such systems and methods map customer interactions to specific attribute-value pairs through a facet management mapping system that connects facet selections to underlying attributes and string matching between search terms and attribute values. Key innovative aspects include combining both facet and search interaction data using a geometric mean ranking approach to provide a composite importance score, filtering interactions based on predicted item types to improve accuracy, daily aggregation of interaction data to enable temporal analysis, and dynamic calculation of importance rankings that can be filtered by time period, item category, and specific attributes.

In examples, a system enables identification of important attributes for different product categories, more efficient item setup processes, improved attribute automation, better presentation of filtering options to customers, and enhanced search functionality through attribute importance awareness. Key components and data flows include input sources from customer facet clicks and search terms, initial processing through facet mapping and string matching, daily data aggregation in partitioned storage, and data presentation through two separate dashboard cards displaying attribute importance rankings and attribute value importance rankings.

In examples, a system processes data through parallel paths for facet click processing and search term processing, with facet clicks mapped to attribute-value pairs using the facet management system and search terms undergoing string matching against attribute values. The system maintains mappings for direct attribute-value correspondences, binned values where multiple attribute values map to a single facet, and numerical range values.

In examples, the system implements a novel automated pipeline that processes daily customer interaction data through parallel facet click and search term pathways, maintains data currency through automated daily aggregation and partitioned storage, and pushes processed data automatically through an automation portal to visualization systems.

The system also introduces ranking capabilities including geometric mean ranking that objectively combines facet click and search interaction data, dynamic rank calculation that updates automatically based on user-selected time periods, and filtered ranking calculations that account for predicted item types to improve accuracy.

In a particular example embodiment, a combination of mapping between facets and MTAs and string matching with search terms is used. The obtained guest interaction counts for MTAs and MTA values reflect the number of times customers faceted or searched for the MTA values. A historical table is created that stores the daily customer interactions based on facet clicks and search. From this table, two display cards are created that display the customer facet click and search interactions with MTAs and MTA values aggregated over a selected period. A dynamic calculation and display of the ranks of the MTAs and MTA values based on both customer interactions through facet clicks and search. In addition, there is performed a calculation of a composite rank that accounts for both the facet click and search rank of the MTAs and MTA values. This composite rank can be considered as providing an overall method for evaluating the importance of MTAs or MTA values based on guest interaction.

Example implementations provided herein provide a technically superior architecture through date-partitioned database tables that enable efficient storage and retrieval of temporal data, automated data consistency management between storage and visualization layers, and real-time calculation capabilities that eliminate manual curation overhead.

The systems and methods described herein also overcome traditional integration limitations by automatically mapping between customer-facing facets and backend attribute systems, processing both direct (facet) and indirect (search) customer interactions, and maintaining synchronized updates across interconnected system components.

These technical advantages enable the system to objectively measure attribute importance based on actual customer behavior while significantly reducing operational overhead compared to conventional manual approaches. The automated processing and dynamic ranking capabilities allow the system to efficiently handle large attribute taxonomies while maintaining data currency and consistency.

In conjunction with the present disclosure, an “attribute” or “Merchandise Type Attribute (MTA)” may correspond to data field used to capture different qualities, handling requirements, or other quantifiable aspects of an item in an e-commerce system. An “Attribute Value” may represent specific permitted value that can be assigned to an attribute. For example, “Red”, “Green”, and “Blue” are possible values for a “Color Family” attribute. Consequently, an “Attribute-Value Pair” represents the combination of a specific attribute and its assigned value, used to characterize an item's properties.

In conjunction with further aspects of the present disclosure, a “Facet” may represent a customer-facing filtering option presented in the e-commerce interface that may correspond to one or more attribute-value pairs. A “Facet Click” may therefore customer interaction where a filtering option (facet) is selected while browsing products to refine search results, and “Facet Management Mapping” corresponds to maintained relationships between customer-facing facets and backend attribute-value pairs, including: direct attribute-value correspondences; binned values where multiple attribute values map to a single facet; and numerical range values.

As described below, the systems and methods as described herein provide several key advantages in processing efficiency through automated data processing that eliminates manual attribute importance assessment via automated daily data aggregation, enables parallel processing of facet clicks and search terms for efficient handling of large data volumes, and utilizes date-partitioned storage architecture for rapid retrieval of temporal data without scanning entire datasets. The scalable data management capabilities include automated mapping between customer-facing facets and backend attributes to eliminate manual mapping overhead, efficient handling of large attribute taxonomies with over 1,000 attributes and 50,000 attribute-value pairs, and automated data consistency management across storage and visualization layers to reduce system maintenance.

Enhanced computational capabilities are achieved through real-time processing features that enable dynamic calculation of rankings based on user-selected parameters without manual recalculation, automated updates of visualizations when filters or time periods change, and efficient simultaneous processing of both direct facet and indirect search interactions. The advanced ranking algorithm employs geometric mean ranking for objective combination of multiple interaction metrics, automated filtering based on predicted item types to improve accuracy, and elimination of manual rank curation through automated daily updates.

System performance improvements include storage optimization through daily partitioned tables that enable efficient data retrieval without full table scans, automated cleanup of null values and below-threshold interactions, and optimized storage of intermediary mapping tables for quick access. The system reduces overhead by eliminating manual attribute importance assessment processes, automating data consistency checks to replace manual verification, and streamlining data flow through an automation portal to reduce system bottlenecks.

Query performance is enhanced through efficient data retrieval capabilities that provide quick access to historical trends via partitioned storage, optimized filtering capabilities for specific time periods and categories, and real-time ranking updates without full data reprocessing. Search functionality is improved through automated string matching using both single-word and n-gram tokens, efficient processing of search terms through parallel pathways, and dynamic updating of search relevance based on attribute importance.

The system maps customer interactions to specific attribute-value pairs by processing two key types of data: facet clicks when customers select filtering options while browsing products, and search terms when customers enter search queries. This mapping is accomplished through a facet management mapping system that connects facet selections to underlying attributes and string matching between search terms and attribute values.

The invention provides particular advantages in large e-commerce systems with extensive attribute taxonomies by enabling data-driven decisions about attribute importance based on actual customer behavior rather than manual curation or assumptions.

To determine the relationship between attribute values and guest interaction, a combination of attribute mapping and string matching to search terms was used. First, a daily interaction count was obtained for particular attributes and values that are based on numbers of facet clicks (e.g., the instances of selection of a particular facet identified by the attribute), and another daily interaction count is obtained from searches of particular attributes or values. These are obtained from Firefly events from Target. com (app and web). A composite of both metrics is also created. The specific attributes and values are ranked over a particular period (e.g., daily, weekly, or some other user-selectable value).

Facet clicks are mapped to attributes using a facet management mapping. Some facets map directly to attributes, while other attributes are not specifically tied to facets. Different event types are captured into tables including a facet management table, an item type—attribute assignment table, and a facet clicks table, and a join between those tables is performed to obtain the facet-attribute mapping and attribute selection count. The search count is obtained from taxonomy values, taxonomy assignments, and a set of search metrics.

When combining facet clicks with search count, a geometric mean of the ranks based on facet clicks and search terms is used, and then the attributes are ranked in order. The use of the geometric mean on the ranks (rather than on the aggregate selections or searches, or some other method) ensures that both types of interactions are accounted for. A straight aggregation would tend to over-weight the search count, since there are far more searches than facet clicks.

Once a ranking of attributes is obtained, observed attribute importance may be visualized. For example, for some types of items (e.g., electronics compatibility), the attribute value list includes brands as attributes (e.g., “Apple compatible”), and in other instances, attributes may not have any associated values for particular products. In further examples, attributes may have very large value lists of possible and often-selected or searched values.

Generally speaking, by obtaining the specific attributes that users in fact care about (based on observed behavior), it is possible to ensure that those attributes are properly associated with values. Because Target introduces a large number of items, it would be preferable to either (1) identify an appropriate minimum set of attributes for which values are required, or (2) automate the attribute assignment process to shorten the time for item setup.

A key technical aspect of the innovation is its use of geometric mean calculations to combine facet click data with search count information, creating a comprehensive importance score for each attribute. The system processes both tangible attributes (such as size, height, weight, material, smell, quantity, and color) and intangible attributes (including quality, reliability, and aesthetics), as well as Product-Defining Qualities (PDQs) and detailed component specifications.

The system's primary objectives are twofold: first, to identify the minimum required attribute set necessary for optimal product presentation and search functionality; and second, to potentially automate the attribute assignment process for new products. This is achieved through continuous monitoring and analysis of guest interaction patterns, creating a dynamic understanding of which attributes are most crucial for different product categories and customer segments.

The implementation includes visualization capabilities for observed attribute importance, enabling data-driven decisions about product information management. This systematic approach to attribute value analysis has demonstrated potential for creating more personalized recommendations, reducing product returns, increasing conversion rates, improving order sizes, and enhancing overall customer lifetime value through improved product differentiation and digital customer experience.

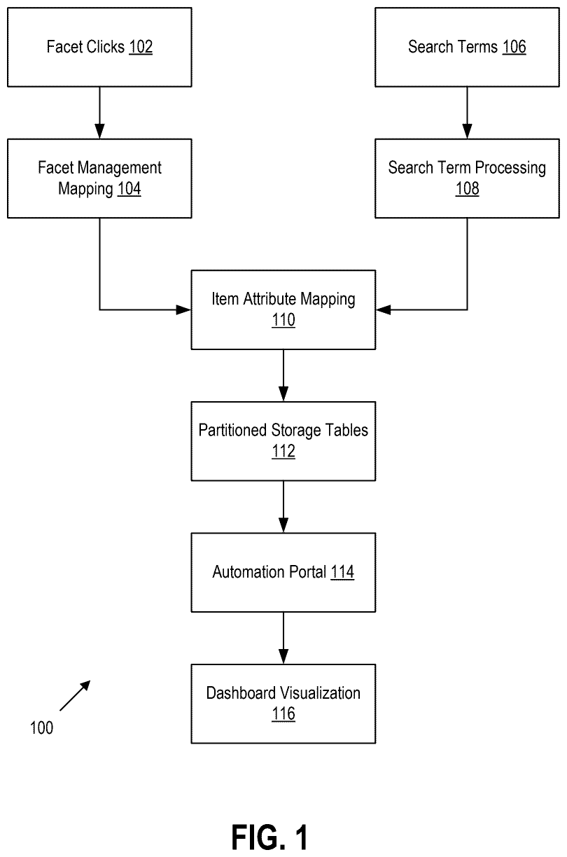

The system architecture diagram of FIG. 1 illustrates a data processing pipeline 100 that begins with two primary customer interaction sources: facet clicks 102 and search terms 106. When customers interact with the e-commerce platform, the system captures facet click data from filtering option selections while browsing products, as well as search term data from customer query entries.

These interaction data streams flow through parallel processing pathways in the system. The facet click data is processed through a facet management mapping system 104 that connects customer-facing facet selections to specific attribute-value pairs, handling direct correspondences, binned values, and numerical ranges. Simultaneously, the search term data undergoes string matching against attribute values through search term processing 108 using both single-word and n-gram token analysis.

The processed data then moves through the item attribute mapping system 110, which maintains the relationships between customer-facing facets and backend attributes while handling both direct and indirect mappings. This mapped data is stored in partitioned storage tables 112, which efficiently organizes attribute identifiers, value identifiers, and interaction counts while enabling quick access to historical trends.

The automation portal 114 serves as an intermediary layer, retrieving the daily aggregated data from the partitioned tables and processing it for dashboard consumption. This component handles automated daily updates, manages data consistency across systems, and controls the data push to the dashboard visualization 116 components. The final stage shows the processed data through the dashboard visualization system, which presents two primary dashboard cards—one for attribute rankings displaying aggregate metrics and another for attribute value rankings with filtering capabilities.

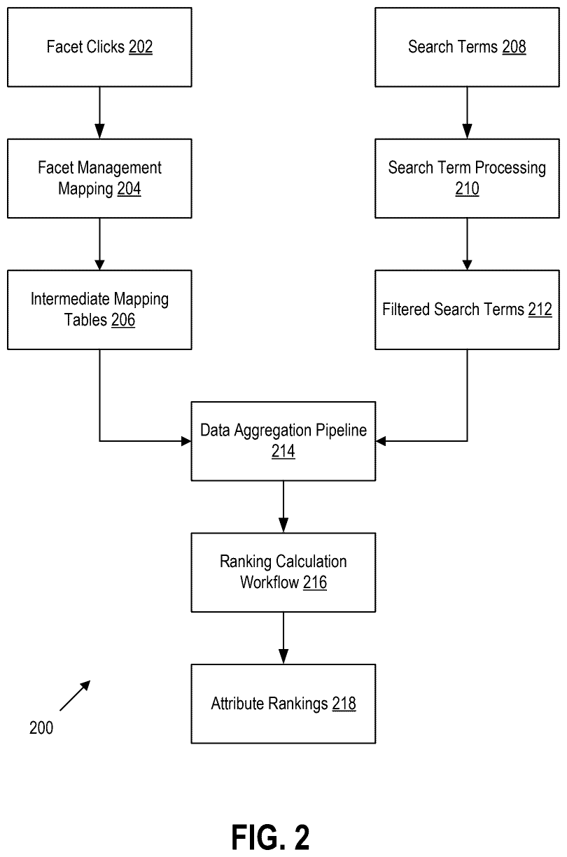

FIG. 2 illustrates the parallel data processing paths 200 that handle facet clicks 202 and search terms 208 within the system. The data flow diagram shows how customer interaction data is processed through two distinct but complementary pathways to generate comprehensive attribute importance rankings.

The facet click processing path begins with the facet management mapping 204, which maintains detailed mappings between customer-facing facets and backend attribute-value pairs. This system handles three distinct mapping types: direct attribute-value correspondences where facets map directly to specific attributes, binned values where multiple attribute values are grouped under a single facet, and numerical range values that span continuous ranges. The facet management system joins these mappings with item type assignments to create intermediate mapping tables 206 that establish clear relationships between customer interactions and specific attributes.

The parallel search term processing 210 path implements sophisticated string matching capabilities to connect customer search queries with relevant attributes. The system generates both single-word tokens and n-gram tokens from search terms, enabling more comprehensive matching against attribute values through filtered search terms 212. This process includes removing null values from the attribute and search term data, filtering search terms to focus on those with interaction counts above defined thresholds, and applying both exact matching and word-level matching techniques to identify relevant attribute-value pairs.

Both processing paths feed into the data aggregation pipeline 214, where the system combines and processes the interaction data to generate metrics. The facet click counts are aggregated by attribute and item type, while maintaining separate counts for individual attribute values within binned categories. Similarly, search term matches are aggregated to provide comprehensive interaction metrics.

The aggregation mechanisms demonstrate how the system processes daily interaction data to maintain current importance rankings. The system joins partitioned tables (described further below) to create aggregated views of attribute importance, enabling quick access to historical trends through the partitioned storage structure. The data retrieval paths illustrate optimized filtering capabilities for specific time periods and categories, allowing real-time ranking updates without full data reprocessing.

These aggregated data streams ultimately flow into the ranking calculation workflow 216, where the system calculates composite rankings using geometric means of the facet click ranks and search term ranks to generate attribute rankings 218, ensuring a balanced representation of both direct and indirect customer interactions.

The geometric mean calculation process can be further detailed through several specific examples. When combining facet clicks with search count data, the system specifically uses a geometric mean of the ranks based on facet clicks and search terms, rather than using the raw aggregate selections or searches. This mathematical approach ensures that both types of interactions are properly weighted, as a straight aggregation would tend to over-weight the search count due to there being far more searches than facet clicks.

The specific calculation process can be illustrated through the following detailed example from the system:
For an attribute “Color Family”:
   Total facet clicks: 2,939,719
   Facet click rank: 1 (highest among all attributes)
   Total searches: 6,585,652
   Search rank: 53
   Composite rank=√(1×53)=7.28
For comparison, “Size Grouping”:
   Facet click count: 4,428,631
   Facet click rank: 6
   Search count: 65,848,730
   Search rank: 10
   Composite rank=√(6×10)=7.75

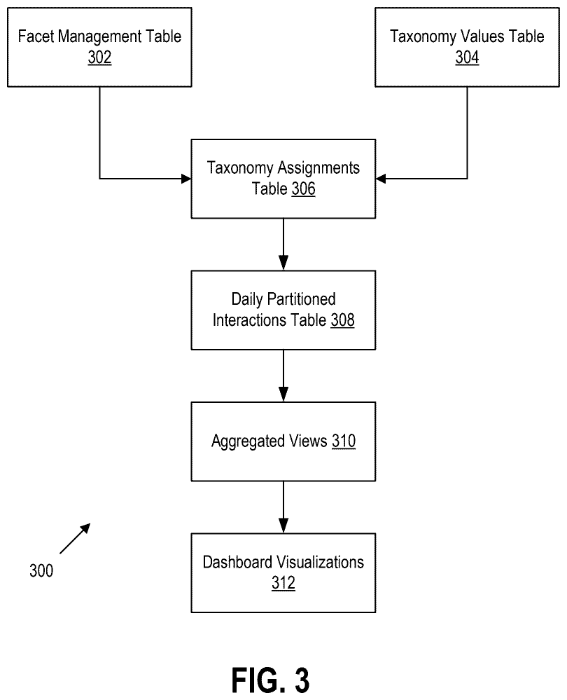

FIG. 3 provides a database schema diagram 300 illustrating the interconnected table structures used to store and process attribute importance data. The system utilizes multiple core database tables that work together to maintain relationships between facets, attributes, values, and customer interactions.

The facet management table 302 stores the mappings between facet identifiers and their corresponding attribute-value pairs. The taxonomy values table 304 contains comprehensive attribute definitions and valid values, while the taxonomy assignments table 306 establishes the links between item types and their applicable attributes.

The daily partitioned interactions table 308 stores the aggregated metrics from customer interactions. This table implements a date-partitioned structure that enables efficient storage and retrieval of temporal data. Each partition contains data elements including attribute identifiers, value identifiers, interaction counts, and item type associations.

The daily partitioned interactions table 308store data elements including attribute identifiers, value identifiers, daily interaction counts, and item type associations. This partitioned architecture enables efficient retrieval of time-based data without requiring full table scans, while separate tables are maintained for facet management mappings, taxonomy values, and taxonomy assignments. The system's storage optimization includes automated cleanup of null values and below-threshold interactions, along with optimized storage of intermediary mapping tables for quick access.

The schema design enables efficient joining operations between these tables to create aggregated views 310 of attribute importance. The facet management table can be joined with the taxonomy tables to establish complete attribute-value relationships, while the daily partitioned interaction table provides the quantitative metrics needed for importance calculations. This integrated structure supports both the storage of raw interaction data and the generation of aggregated views that power the dashboard visualizations 312, maintaining data consistency while enabling real-time calculation of attribute importance rankings.

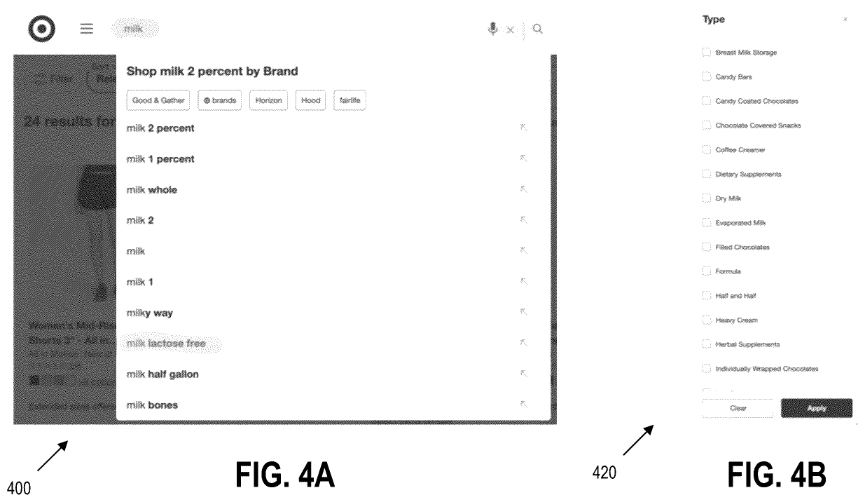

FIG. 4A demonstrates the search process interface 420 displaying search results and filtering capabilities for milk-related products. The interface shows search refinement options including brand-based filtering (such as “Good & Gather,” “Horizon,” “Hood fairlife”) and various milk-related search terms like “milk 2 percent,” “milk 1 percent,” “milk whole,” along with associated search result counts and filtering options. The interface enables users to dynamically refine their search results through multiple filtering dimensions while maintaining the relationship between search terms and attribute values.

FIG. 4B illustrates a type selection interface 420 showing filtering options for product categories, including checkbox selections for various milk-related products such as “Breast Milk Storage,” “Candy Bars,” “Candy Coated Chocolates,” “Chocolate Covered Snacks,” “Coffee Creamer,” “Dietary Supplements,” “Dry Milk,” “Evaporated Milk,” “Filled Chocolates,” “Formula,” “Half and Half,” “Heavy Cream,” “Herbal Supplements,” and “Individually Wrapped Chocolates,” with clear and apply options for filter selection.

Together, these figures illustrate how the system implements both faceted navigation through search-based exploration (4A) and type-based filtering (4B) to capture customer interactions and preferences for attribute importance calculation.

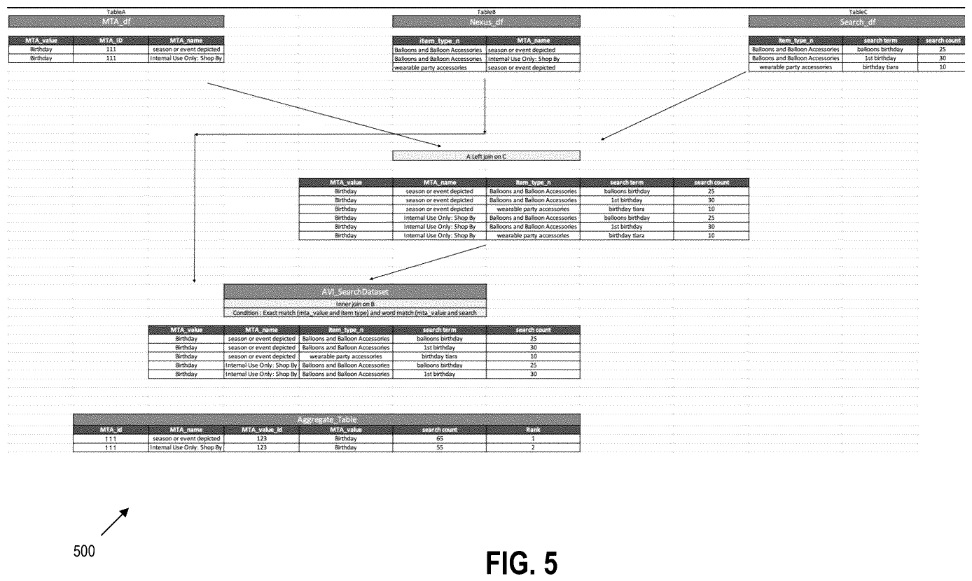

FIG. 5 illustrates a process flow diagram 500 showing the data mapping and integration between multiple database tables to generate attribute importance rankings. The diagram demonstrates how three primary tables—Table A (MTA\_df), Table B (Nexus\_df), and Table C (Search\_df)—are joined and processed to create comprehensive attribute importance metrics.

Table A contains the foundational MTA data, including MTA\_value, MTA\_ID, and MTA\_name fields. Table B maintains the relationships between item types and MTAs through the item\_type\_n and MTA\_name fields. Table C captures the search interaction data, containing item\_type\_n, search term, and search count information.

The system implements two key string-matching conditions to process and combine this data. The first condition performs exact matching between MTA values and item types, while the second condition implements word matching between MTA values and search terms. These matching processes enable the system to accurately map customer search interactions to specific attribute-value pairs.

The resulting joined dataset (AVI\_Search Dataset) combines these tables through an inner join on Table B, applying both the exact match and word match conditions. This creates comprehensive records containing MTA\_value, MTA\_name, item\_type\_n, search term, and search count information. The system then aggregates this data into a final table (Aggregate\_Table) that includes MTA\_id, MTA\_name, MTA\_value\_id, MTA\_value, search count, and rank information.

This process enables the calculation of composite rankings using geometric means of the facet click ranks and search term ranks, ensuring a balanced representation of both direct and indirect customer interactions. The diagram illustrates how the system efficiently processes large volumes of customer interaction data while maintaining accurate relationships between attributes, values, and customer search behavior.

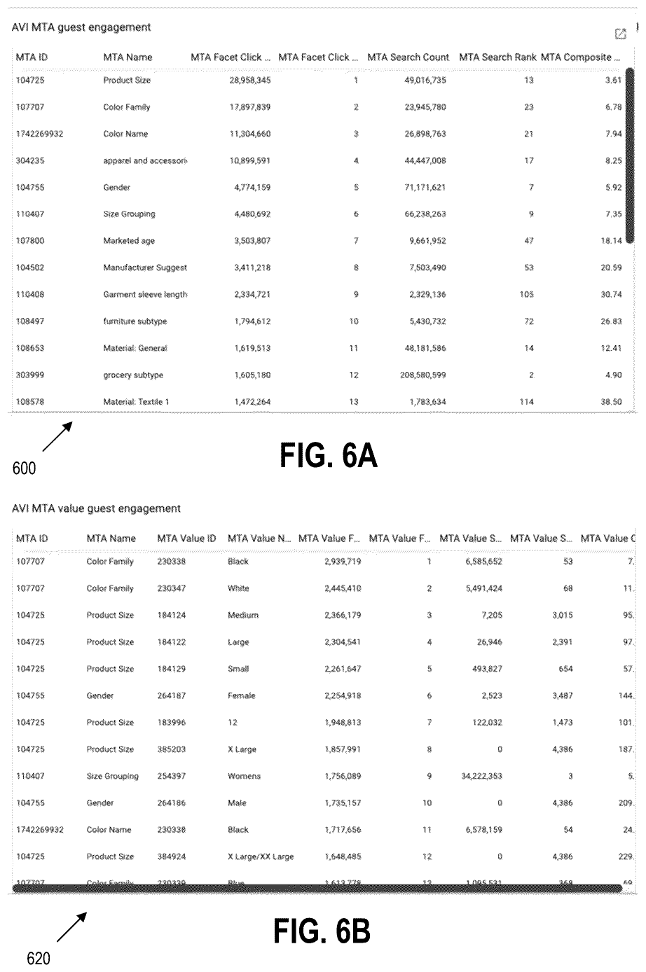

FIGS. 6A and 6B illustrate the dashboard interface design that presents attribute importance data through two primary visualization cards. The dashboard interface diagram shows the detailed layout and components that enable users to analyze and interact with the attribute importance rankings.

The first card, shown in FIG. 6A, is an Attribute Rankings Card 600, which displays three key metrics: aggregate facet click counts showing direct customer interactions with filtering options, search term interaction metrics indicating how frequently attributes appear in customer searches, and composite ranking scores calculated using geometric means. This card enables users to quickly identify the most important attributes based on actual customer behavior patterns. The interface includes dynamic filtering capabilities that allow users to adjust the time period of analysis, focus on specific item categories, and select particular attributes of interest.

The second card, shown in FIG. 6B, is an Attribute Value Rankings Card 620, which provides a detailed view of value-specific metrics within individual attributes. This card enables users to select specific attributes and view ranked importance scores for all associated values. The interface updates these rankings in real-time as users modify filter selections, providing immediate insight into how different attribute values perform across various dimensions. The card includes temporal trend displays that show how value importance changes over time and category-specific views that highlight value performance within particular product segments.

Both cards incorporate sophisticated filtering controls that enable users to refine the displayed data. These controls include time period selectors for analyzing temporal trends, category filters for focusing on specific product segments, and attribute selection tools for detailed analysis of particular attributes. The ranking visualization components implement comparative displays that show relative importance scores, making it easy to identify patterns and prioritize attributes based on customer interaction data. The interface automatically updates all visualizations when users modify any filter settings, ensuring that the displayed rankings always reflect the current selection criteria.

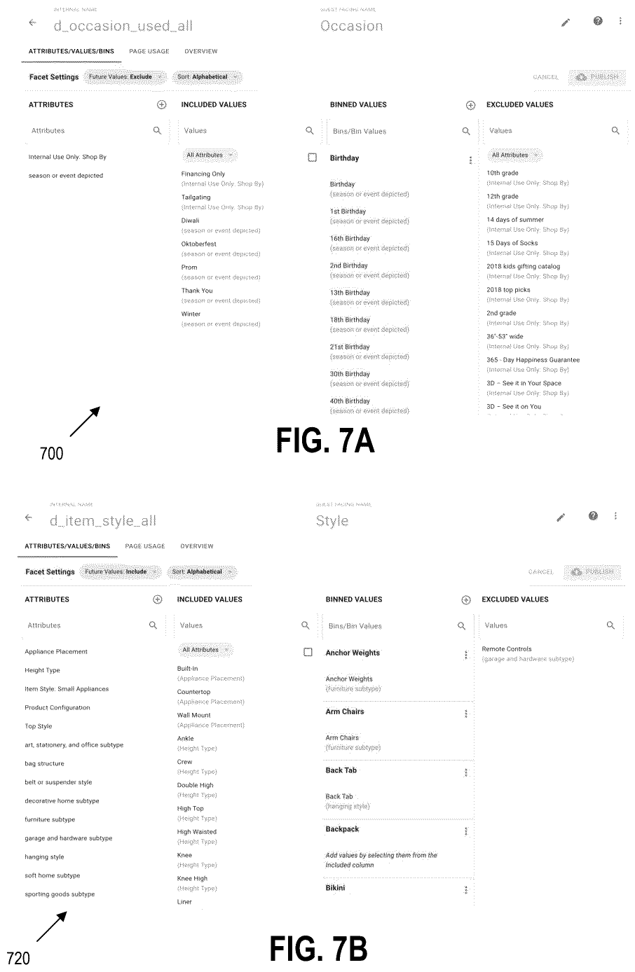

FIG. 7A illustrates a facet management interface showing the internal organization and mapping of attribute values. The interface displays an “INTERNAL NAME” field with corresponding “GUEST FACING NAME” fields, demonstrating how the system maintains relationships between backend attribute identifiers and customer-facing facet displays. The interface includes sections for managing attributes, values, and bins, with capabilities for including, excluding, and binning specific values. The interface shows example attributes such as “Internal Use Only: Shop By” and “season or event depicted” along with their associated values like “Birthday” and various anniversary-related entries.

FIG. 7B demonstrates an expanded view of the facet management interface, showing additional attribute management capabilities. The interface includes “Facet Settings” with options for handling future values and sorting methods, along with sections for “ATTRIBUTES,” “INCLUDED VALUES,” and “BINNED VALUES.” The interface displays detailed attribute mappings for items such as “Appliance Placement” with corresponding values like “Built-In,” “Countertop,” and “Wall Mount,” demonstrating how the system maintains complex attribute-value relationships. This interface enables efficient management of attribute taxonomies while maintaining the relationships between internal attribute systems and customer-facing facets.

Both interfaces work together to support the system's automated mapping between customer-facing facets and backend attributes, enabling efficient handling of large attribute taxonomies with over 1,000 attributes and 50,000 attribute-value pairs. The interfaces facilitate the maintenance of three distinct mapping types: direct attribute-value correspondences, binned values where multiple attribute values map to a single facet, and numerical range values.

Additional visualizations may be presented to a user beyond those shown in the above figures. For example, visualizations may include an attribute importance rankings display that shows the relative rankings of different attributes based on their composite importance scores. Such a comparative rankings display enables users to quickly identify the most significant attributes based on actual customer interaction data, presenting both the individual facet click and search term metrics as well as the composite geometric mean rankings. The visualization implements clear visual hierarchies to highlight the relative importance of different attributes while maintaining the mathematical integrity of the underlying calculations.

A temporal analysis view component of the visualization may show how attribute importance changes over time. This view enables users to track trends in customer interaction patterns and identify shifts in attribute importance across different time periods. The visualization automatically updates to reflect user-selected time ranges, providing immediate insight into temporal patterns while maintaining consistency with the underlying daily partitioned data structure.

A category-specific rankings section of the visualization may illustrate how attribute importance varies across different product categories. This view enables users to understand how different attributes perform within specific product segments, helping identify category-specific patterns in customer behavior. The visualization includes filtering capabilities that allow users to focus on particular product categories while maintaining the relationship between the displayed rankings and the composite geometric mean calculations that drive the underlying importance scores.

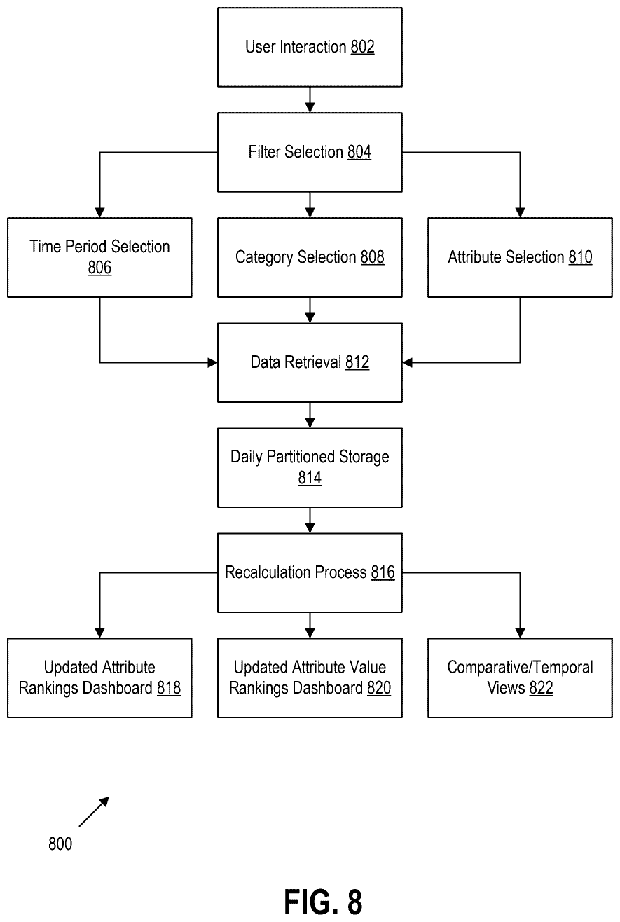

FIG. 8 is a user interface flow diagram 800 that demonstrates the interactive process of filtering and viewing attribute importance data through the dashboard interface. The diagram illustrates how users can refine and analyze the rankings data through multiple selection steps and see immediate updates to the displayed results, e.g., through user inputs 802.

The filter selection process 804 shows how users can apply various filtering criteria to focus their analysis. This includes the ability to select specific time periods for temporal analysis, choose particular product categories to examine category-specific patterns, and select individual attributes for detailed investigation. The interface maintains consistency across these filtering options while enabling users to quickly refine their view of the attribute importance data.

The time period selection component 806 demonstrates how users can analyze temporal trends in attribute importance. The interface enables selection of different date ranges, with the system automatically retrieving the relevant data from the daily partitioned storage structure. The category selection process 808 allows users to focus on specific product segments, helping identify patterns in attribute importance across different types of items. The attribute selection capability 810 enables detailed investigation of specific attributes and their associated values.

The results display updates portion of the diagram shows how the interface dynamically responds to user selections. When users modify any filter settings, the system automatically recalculates rankings based on the selected criteria and updates all visualization components accordingly. This includes updating the attribute rankings card, attribute value rankings card, and any comparative displays or temporal analysis views, ensuring that all displayed data consistently reflects the current filter selections while maintaining the mathematical integrity of the geometric mean calculations.

The system specifically uses the geometric mean on the ranks rather than the raw counts to ensure that attributes must rank highly in both facet clicks and search terms to achieve a strong composite ranking. This prevents attributes from achieving high importance based on strong performance in only one metric. The calculation maintains mathematical integrity while enabling dynamic updates based on user-selected filters and time periods.

For binned values, the system implements additional computational logic—counting a single guest interaction for the attribute when any binned value is selected, while maintaining separate guest interaction counts for each individual attribute value within the bin. This ensures accurate ranking calculations when dealing with grouped attribute values.

The system implements specific computational logic for different attribute value types. For direct attribute-value pairs, standard geometric mean calculation are used. For binned values, single guest interactions are counted for the attribute when any binned value is selected, while maintaining separate guest interaction counts for individual values within the bin. For numerical range values, each is processed as a distinct attribute-value mapping.

The geometric mean approach specifically prevents attributes from achieving artificially high importance based on strong performance in only one metric. A straight aggregation would skew results toward search counts since there are typically far more searches than facet clicks. By using the geometric mean of ranks rather than raw counts, the system ensures that truly important attributes must demonstrate strong performance in both interaction types.

The system implements filtering based on predicted item types as a crucial preprocessing step before calculating attribute importance rankings. This filtering process works through several specific mechanisms. For example, the system utilizes a taxonomy assignments table that establishes links between item types and their applicable attributes. This table mapping enables the system to filter interactions based on relevant attribute-item type assignments before performing rank calculations. When processing facet click data, the system as described (1) receives input from the facet management table containing relationships between facet identifiers and attribute-value pairs, (2) joins this with the item type mapping table to create an intermediary mapping table, (3) filters out counts that lack relevant attribute-item type assignments, and (4) identifies distinct attribute-facet-value-item type entries before aggregating click counts.

The filtering process improves ranking accuracy by ensuring that attributes are only evaluated within relevant product contexts. For example, when calculating rankings for a specific category of items, the system automatically filters interactions to focus on predicted item types associated with that category, preventing irrelevant attribute interactions from affecting the importance calculations.

This filtered approach enables automated filtering based on predicted item types to improve ranking accuracy, as well as efficient handling of large attribute taxonomies (1000+ attributes, 50,000+ attribute-value pairs).

The system maintains data consistency through automated cleanup of null values and below-threshold interactions as part of this filtering process, ensuring that the subsequent geometric mean calculations are performed on properly filtered and relevant data.

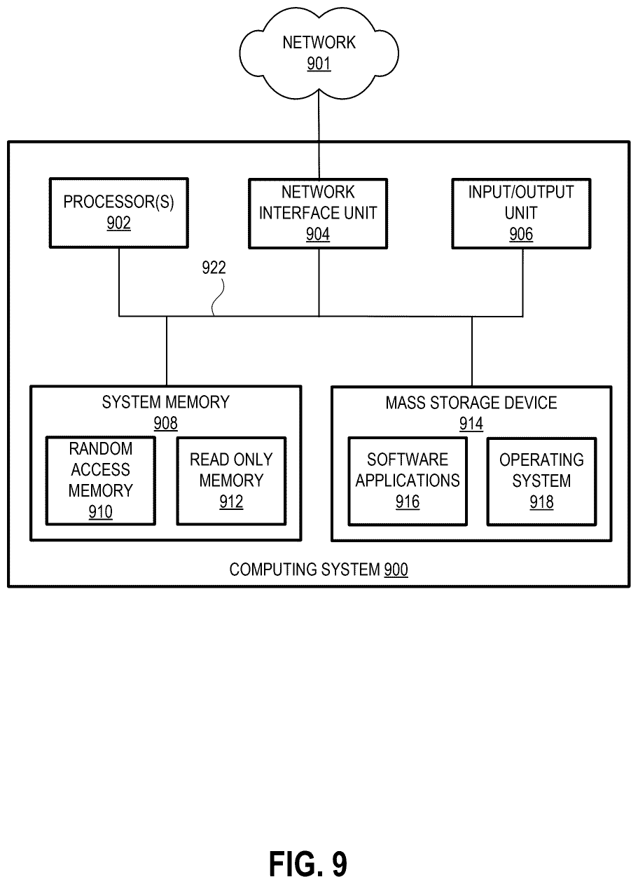

FIG. 9 illustrates an example block diagram of a virtual or physical computing system 900. One or more aspects of the computing system 900 can be used to implement the systems described herein, store instructions described herein, and perform operations described herein.

In the embodiment shown, the computing system 900 includes one or more processors 902, a system memory 908, and a system bus 922 that couples the system memory 908 to the one or more processors 902. The system memory 908 includes RAM (Random Access Memory) 910 and ROM (Read-Only Memory) 912. A basic input/output system that contains the basic routines that help to transfer information between elements within the computing system 900, such as during startup, is stored in the ROM 912. The computing system 900 further includes a mass storage device 914. The mass storage device 914 is able to store software instructions and data. The one or more processors 902 can be one or more central processing units or other processors.

The mass storage device 914 is connected to the one or more processors 902 through a mass storage controller (not shown) connected to the system bus 922. The mass storage device 914 and its associated computer-readable data storage media provide non-volatile, non-transitory storage for the computing system 900. Although the description of computer-readable data storage media contained herein refers to a mass storage device, such as a hard disk or solid-state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, DVD (Digital Versatile Discs), other optical storage media, magnetic cassettes, magnetic tape, magnetic disk storage or other magnetic storage devices, or any other medium which can be used to store the desired information and which can be accessed by the computing system 900.

According to various embodiments of the invention, the computing system 900 may operate in a networked environment using logical connections to remote network devices through the network 901. The network 901 is a computer network, such as an enterprise intranet and/or the Internet. The network 901 can include a LAN, a Wide Area Network (WAN), the Internet, wireless transmission mediums, wired transmission mediums, other networks, and combinations thereof. The computing system 900 may connect to the network 901 through a network interface unit 904 connected to the system bus 922. It should be appreciated that the network interface unit 904 may also be utilized to connect to other types of networks and remote computing systems. The computing system 900 also includes an input/output controller 906 for receiving and processing input from a number of other devices, including a touch user interface display screen, or another type of input device. Similarly, the input/output controller 906 may provide output to a touch user interface display screen or other type of output device.

As mentioned briefly above, the mass storage device 914 and the RAM 910 of the computing system 900 can store software instructions and data. The software instructions include an operating system 918 suitable for controlling the operation of the computing system 900. The mass storage device 914 and/or the RAM 910 also store software instructions, that when executed by the one or more processors 902, cause one or more of the systems, devices, or components described herein to provide functionality described herein. For example, the mass storage device 914 and/or the RAM 910 can store software instructions that, when executed by the one or more processors 902, cause the computing system 900 to receive and execute managing network access control and build system processes.

Referring to FIGS. 1-9 generally, a method for ranking MTAs and MTA values based on guest engagement is presented. The methods and systems account for guest engagement based on both facet clicks and search. The composite ranking method we have presented here provides an easy method to rank and identify important MTAs and MTA values based on guest engagement.

While the method presented here provides a ranking of MTAs and MTA values that intuitively seems reasonable, it is worth noting some potential cases that require extra care. First, the string matching used in mapping searches to MTAs and MTA values can potentially result in overestimating guest engagement for some MTAs. For MTAs this can partly result from the MTA including many values that match a large set of search terms. Overestimation for an MTA may also result from a lack of capturing the intention of the search related to an MTA. The clearest example of this is the value “Milk” for the allergy statement, contains MTA. The string matching will count all searches for “milk” as guest engagement with this MTA. However, in this case, when a guest is searching for “milk”, it is unlikely that they are interested in the allergy statement, contains MTA. The second case that requires extra care is the binning of multiple MTA values into a single facet value. An example of this can be seen in Table 5. Here all the anniversary values of the season or event depicted MTA are assigned equal guest interaction, while it is reasonable to suspect some of these values would be used more frequently than others. For both cases, looking at the ranking based on the other source of guest engagement (facet clicks or search) may provide some insight that is lost from the other source. In general, if the ranking of an MTA or MTA value in these tables does not make sense, a good first step is to look at the rank and counts for both facet clicks and search in addition to the composite rank. The geometric mean ranking method ensures that attributes must rank highly in both facet clicks and search terms to achieve a strong composite ranking, preventing attributes from achieving high importance based on strong performance in only one metric.

Still referring to FIGS. 1-9 generally, the systems and methods disclosed herein enable several key end use cases for determining attribute importance in e-commerce environments. Product data management teams can leverage the attribute importance data to maintain and update item taxonomies based on actual customer usage patterns, while item data quality teams can prioritize their manual processes by focusing on the most important attributes. The system supports critical decisions about which attributes should be required during item setup and helps optimize the product information management process.

Search and navigation capabilities are enhanced through improved ordering of faceted filters based on customer interaction patterns and more efficient vector search capabilities that leverage identified important attributes. The system enables better product information display by improving product detail page presentations and creating more effective product titles that incorporate the most relevant attributes, ultimately enhancing purchase confidence by surfacing the attributes customers care about most.

The technology supports automation and efficiency improvements through the development of item data ontologies that identify key attribute slots and potentially automate the attribute assignment process for new products. This helps identify the minimum required attribute set necessary for optimal product presentation while maintaining data quality.

Customer experience is significantly enhanced through the system's ability to create more personalized recommendations and reduce product returns through better attribute presentation. The technology drives increased conversion rates and order sizes through improved product differentiation, while enhancing overall customer lifetime value through an improved digital customer experience that surfaces the most relevant product attributes.

While particular uses of the technology have been illustrated and discussed above, the disclosed technology can be used with a variety of data structures and processes in accordance with many examples of the technology. The above discussion is not meant to suggest that the disclosed technology is only suitable for implementation with the data structures, systems, and methods shown and described above.

This disclosure described some aspects of the present technology with reference to the accompanying drawings, in which only some of the possible aspects were shown. Other aspects can, however, be embodied in many different forms and should not be construed as limited to the aspects set forth herein. Rather, these aspects were provided so that this disclosure was thorough and complete and fully conveyed the scope of the possible aspects to those skilled in the art.

As should be appreciated, the various aspects (e.g., operations, memory arrangements, etc.) described with respect to the figures herein are not intended to limit the technology to the particular aspects described. Accordingly, additional configurations can be used to practice the technology herein and/or some aspects described can be excluded without departing from the methods and systems disclosed herein.

Similarly, where operations of a process are disclosed, those operations are described for purposes of illustrating the present technology and are not intended to limit the disclosure to a particular sequence of operations. For example, the operations can be performed in differing order, two or more operations can be performed concurrently, additional operations can be performed, and disclosed operations can be excluded without departing from the present disclosure. Further, each operation can be accomplished via one or more sub-operations. The disclosed processes can be repeated.

Although specific aspects were described herein, the scope of the technology is not limited to those specific aspects. One skilled in the art will recognize other aspects or improvements that are within the scope of the present technology. Therefore, the specific structure, acts, or media are disclosed only as illustrative aspects. The scope of the technology is defined by the following claims and any equivalents therein.

1. A computer-implemented method for determining attribute importance in an e-commerce system, comprising:
receiving facet click data indicating customer selections of facet values for filtering products;
receiving search term data indicating customer search queries;
mapping the facet click data to attribute-value pairs using a facet management mapping system;
mapping the search term data to attribute-value pairs using string matching;
calculating, for each attribute:
a first rank based on aggregated facet click counts,
a second rank based on aggregated search term counts, and
a composite rank using a geometric mean of the first and second ranks; and
storing the composite ranks in a database.

2. The method of claim 1, further comprising
displaying a first dashboard card showing attribute rankings based on:
aggregated facet click counts,
aggregated search term counts, and
composite ranks calculated using geometric means;
displaying a second dashboard card showing attribute-value rankings based on the aggregated facet click counts, the aggregated search term counts, and the composite ranks calculated using geometric means;
enabling dynamic filtering of both dashboard cards by:
time period selection,
item category, and
specific attributes.

3. The method of claim 2, wherein displaying the first dashboard card comprises:
retrieving daily aggregated interaction data from a partitioned database;
calculating ranks dynamically based on user-selected date ranges;
displaying for each attribute:
total facet click count,
total search count, and
composite ranking score.

4. The method of claim 2, wherein displaying the second dashboard card comprises:
enabling selection of a specific attribute;
displaying ranked importance scores for all values associated with the selected attribute; and
updating the displayed rankings in real-time when filter selections change.

5. The method of claim 1, wherein mapping the search term data comprises:
maintaining a taxonomy values table mapping attribute identifiers to attribute names and values;
maintaining a taxonomy assignments table mapping item types to attributes;
joining the taxonomy tables with search metrics data based on:
exact matches between attribute values and item types, and
word matches between attribute values and search terms.

6. The method of claim 5, wherein mapping the search term data further comprises:
generating single-word tokens from the search terms;
generating n-gram tokens from the search terms; and
matching the tokens against attribute values to identify relevant attribute-value pairs.

7. The method of claim 1, wherein the facet management mapping system comprises:
a first mapping type for direct attribute-value correspondences;
a second mapping type for binned values where multiple attribute values map to a single facet value; and
a third mapping type for numerical range values.

8. The method of claim 1, further comprising:
filtering the facet click data and search term data based on predicted item types associated with customer interactions.

9. The method of claim 1, wherein mapping the search term data comprises:
identifying matches between search terms and attribute values using single-word tokens and n-gram tokens.

10. The method of claim 1, further comprising:
aggregating the facet click data and search term data on a daily basis; and
storing the aggregated data in a partitioned database table.

11. The method of claim 1, further comprising:
receiving a selected time period; and
recalculating the composite ranks using only facet click data and search term data from the selected time period.

12. The method of claim 1, wherein mapping the facet click data comprises:
receiving a facet management table containing relationships between facet identifiers, facet values, and corresponding attribute-value pairs;
receiving a table mapping item types to attributes;
joining the facet management table and item type mapping table to create an intermediary mapping table;
filtering the intermediary mapping table to remove counts without relevant attribute-item type assignments.

13. The method of claim 12, wherein mapping the facet click data further comprises:
identifying distinct attribute-facet-value-item type entries from the intermediary mapping table;
aggregating facet click counts grouped by attribute and item type; and
storing the aggregated click counts in a final aggregated table.

14. The method of claim 13, wherein for binned values:
counting a single guest interaction for the attribute when any binned value is selected;
counting separate guest interactions for each individual attribute value within the bin.

15. The method of claim 1, wherein string matching comprises:
removing null values from attribute and search term data;
filtering search terms to those with interaction counts above a threshold;
applying both exact matching and word-level matching between search terms and attribute values.

16. A system for evaluating attribute importance in an e-commerce platform, comprising:
a database storing merchandise type attributes and associated values;
a facet management system mapping facet selections to attribute-value pairs;
a search processing system mapping search terms to attribute-value pairs;
a ranking engine configured to:
calculate first ranks based on facet selection counts,
calculate second ranks based on search term counts, and
calculate composite ranks using geometric means of the first and second ranks.

17. The system of claim 16, wherein the ranking engine is further configured to:
filter interactions based on predicted item types before calculating ranks.

18. The system of claim 16, further comprising:
a dashboard interface displaying attribute rankings filtered by:
time period,
item category, and
specific attributes.

19. A method for storing and retrieving attribute importance data in an e-commerce system, comprising:
storing daily aggregated data in a partitioned table including:
facet click counts for attribute-value pairs,
search term counts for attribute-value pairs, and
predicted item types associated with interactions;
partitioning the table by date to enable efficient retrieval of time-based data, wherein separate tables are maintained for facet management mappings, taxonomy values, taxonomy assignments;
storing for each partition:
attribute identifiers,
attribute value identifiers,
daily interaction counts, and
item type associations, and
joining the tables to create aggregated views of attribute importance.

20. The method of claim 19, wherein the aggregated views include:
a first dashboard view showing attribute rankings based on:
aggregated facet click counts,
aggregated search term counts, and
composite ranks calculated using geometric means; and
a second dashboard view showing attribute-value rankings based on the aggregated facet click counts, the aggregated search term counts, and the composite ranks calculated using geometric means.
